(19) United States
(12) Patent Application Publication
(10) Pub. No.: US 2008/0175460 A1
(43) Pub. Date: Jul. 24, 2008

(54) Pacs portal with automated data mining and software selection

(76) Inventor: Bruce Reiner, Berlin, MD (US)

Correspondence Address: AKERMAN SENTERFITT, 801 PENNSYLVANIA AVENUE N.W., SUITE 600, WASHINGTON, DC, 20004, US

(21) Appl. No.: 12/000,932

(22) Filed: Dec. 19, 2007

Related U.S. Application Data
(60) Provisional application No. 60/875,540, filed on Dec. 19, 2006.

(51) Int. Cl. G06K 9/00

(52) U.S. Cl. 382/131

(57) ABSTRACT

The present invention relates to a single, fully integrated image archival and workflow system, that provides instantaneous access to a variety of software programs, which are customized using user-specific profiles from a database which includes predetermined workflow preferences. The customized software applications are used during image analysis and interpretation, and can be automated to be retrieved during image studies. When multiple programs are available for a given single study or combination of studies, then the system can either use preselected programs, or can allow the user the option of selecting the ones most appropriate for use. The system has the capability of obtaining feedback from the users as to whether the software was appropriate for the given study or studies for future reference.

### CROSS-REFERENCE TO RELATED APPLICATIONS

The present invention claims priority from U.S. Provisional Patent Application No. 60/875,540, filed Dec. 19, 2006, the contents of which are herein incorporated by reference in their entirety.

### BACKGROUND OF THE INVENTION

1. Field of the Invention

The present invention relates to a single, fully integrated picture archival and communication system (PACS) workstation, that provides transparent and instantaneous access to a variety of software programs, each of which is fully integrated into a single workflow engine.

2. Description of the Related Art

Existing picture archival and communication systems (PACS) have changed from an architectural perspective over the past several years. Initial systems emulated film view boxes. With these systems, images were transferred to a computer workstation along with relevant prior studies in anticipation of those studies being interpreted by a radiologist (or other interpreting physician) or non-interpreting health care provider. This model was required due to limitations of computer network speed and computer performance that made it impractical to have studies made available on demand. It required a computer with a large memory, and the major limitation was the need to anticipate the images needed by each radiologist/interpreting physician (R/IP).

The next major advance was one in which images were made available for transfer on an as-needed basis. This required a faster network and added tremendous flexibility for the R/IP and clinicians using the PACS to specify the images they needed at the time of interpretation or review as well as relevant other studies. This obviated the requirement to prefect studies and made it easier to have images available anytime and anywhere.

A variant of this architecture is one that uses on-the-fly (on demand) compression that can take an original dataset and transfer images to fit the resolution of a monitor on a real time/as-needed basis. Advanced workstation vendors have or are currently migrating toward the use of this type of server-side rendering in which the graphical processing and image loading takes place at a server that is located remotely.

With this architecture, the clients (workstations) have software that opens up a window into the server, and actions such as window/level, zoom, rotate, etc., performed by the R/IP or other healthcare workers, are requested at the workstation using a variety of input devices (e.g., mouse, trackball, game controller, stylus), performed on the server and then displayed on the client workstation.

The limitations of this architecture currently are that users currently are required to load software for each of the multiple applications used in diagnostic imaging. This is due to the fact that each commercial image visualization and analysis system is optimized for a specific subset of tasks. Consequently radiologists, nuclear medicine physicians, and other primary interpreting physicians and clinicians must run multiple different software programs, often on multiple different computer workstations.

Vendors within the medical imaging and information systems sectors have held onto this concept of proprietary PACS workstations because it creates the mentality of “one size fits all” and creates a dependence of the healthcare practitioner on a single vendor. While many technology users prefer a “best of breed” approach, this has to date not been practical when it comes to the myriad of applications intrinsic to PACS. The multiple steps that occur in the imaging chain (i.e., image acquisition, archival, transmission, display, processing, interpretation, and reporting) are intrinsically tied to a single PACS, thereby requiring the end-user to adapt to a single vendor's technology.

The alternative, which is often practiced, is to have multiple, stand-alone workstations, each performing a single set of functions within the imaging chain. For example, a radiologist who wants to simultaneously review nuclear medicine and MRI exams on a single patient is often tasked with migrating between several different workstations, one for review of the nuclear medicine (e.g., PET/CT exam), one for the MRI exam, and another for advanced (2/3-D multi-planar) image processing. If that same radiologist wants to extract clinical data on the patient in question, he/she needs to search a separate workstation tied to the patient electronic medical record (EMR). For reporting (using a structured reporting application), the radiologist now needs to access a separate computer workstation that may or may not have an integrated critical results reporting package. If that is not enough, the radiologist may want to utilize a number of computerized decision support applications during the interpretation process, each of which may require separate software applications, each with its own computer workstation. While some of these applications may be “integrated” into the central PACS architecture, the integration is limited in scope and functionality. In reality, it requires opening up a separate application from the main PACS workflow engine, which takes time and valuable memory.

Thus, a single, fully integrated PACS workstation that provides transparent and instantaneous access to a variety of software programs, each of which is fully integrated into a single workflow engine, is needed. This type of alternative architectural configuration can be provided to address many of the challenges associated with the existing PACS, which can be used as a “portal” for radiological and other medical applications, as well as non-medical applications.

### SUMMARY OF THE INVENTION

Thus, the present image archival and workflow system includes a single, fully integrated picture archival and communication system (PACS) workstation, that provides transparent and instantaneous access to a variety of software programs, each of which is fully integrated into a single workflow engine.

The system of the present invention is programmed to “listen for” or retrieve HL7 (or other standards-based) messages and create a list of imaging studies (or other healthcare studies or procedures in the case of a non-imaging portal) for the user. The user (i.e., a radiologist in the event of a medical application, for example) can then create a filter that can display or manipulate a subset of the list of all studies or procedures performed and create an interpretation worklist from this filter.

In a medical application, for example, a clinician can create a list of his/her patients, tumor board cases, or another type of subset of the total number of procedures as well. The portal then can automatically bring up the appropriate viewer for the defined study. For example, a CT of the abdomen and comparison study might be viewed on a generic 3D cross sectional server side display program while an ultrasound study of the heart might be viewed using a cardiology echocardiography display and quantitative analysis program.

The imaging archival and workflow system, or “portal”, of the present invention takes a given study on the “worklist” and then uses group- or user-defined protocols to determine the appropriate software to view the study. The images are then retrieved by the program from a central storage device or a distributed one and sent to the appropriate server or servers for interactive rendering and analysis and image optimization. When multiple programs are available for a given single study or combination of studies, then the system can either use preselected server-side rendering programs, or alternatively can allow the user the option of selecting the ones most appropriate for use. The system has the capability of obtaining feedback from the users as to whether the software was appropriate for the given study or studies for future reference (satisfaction score).

One advantage of this approach includes the fact that images do not need to be sent to the interpreting radiologists or clinicians, for example, which can take a great deal of time, but rather, the connection speed from the servers to the archive needs to be very high, which is easier to accomplish than achieving a similarly fast connection speed to each user. The system allows individual display and image processing and enhancement vendors to create their own hardware and software solutions using technologies such as clustering or grid computing to optimize performance. However, the vendors would need to adopt the standard of the “portal” for accessing the software package. The “portal” would define “standards or conventions” that could be used to make the user interface to various software packages more uniform and thus easier to use.

Another advantage of the approach would be that users could pick “best of breed” solutions to individual imaging display and analysis and optimization and decision support tasks and then pay for the use of the appropriate software using a pay-per-use model (although multiple different business models could be employed). The “portal” of the present invention, keeps track of which software is being utilized. Users could have a large number of options for image display and analysis and could change when desired. This would allow subspecialized applications to be developed for niche applications such as cardiac CT or MR, spectroscopy, obstetrical ultrasound, and so on, by vendors who have the expertise in those areas and who are not able to compete as complete PACS providers.

Performance over this system would be expected to be faster than solutions that require processing and display to occur at the local workstation. Auditing access to patients and various software functions would be centralized and performed by the “portal” software.

The foregoing summary has outlined some features consistent with the present invention in order that the detailed description thereof that follows may be better understood, and in order that the present contribution to the art may be better appreciated. There are, of course, additional features consistent with the present invention that will be described below, and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram of the apparatus used in one embodiment consistent with the present invention.

FIG. 2 is a flow chart of steps taken by the program used by the image archival and workflow system of the present invention.

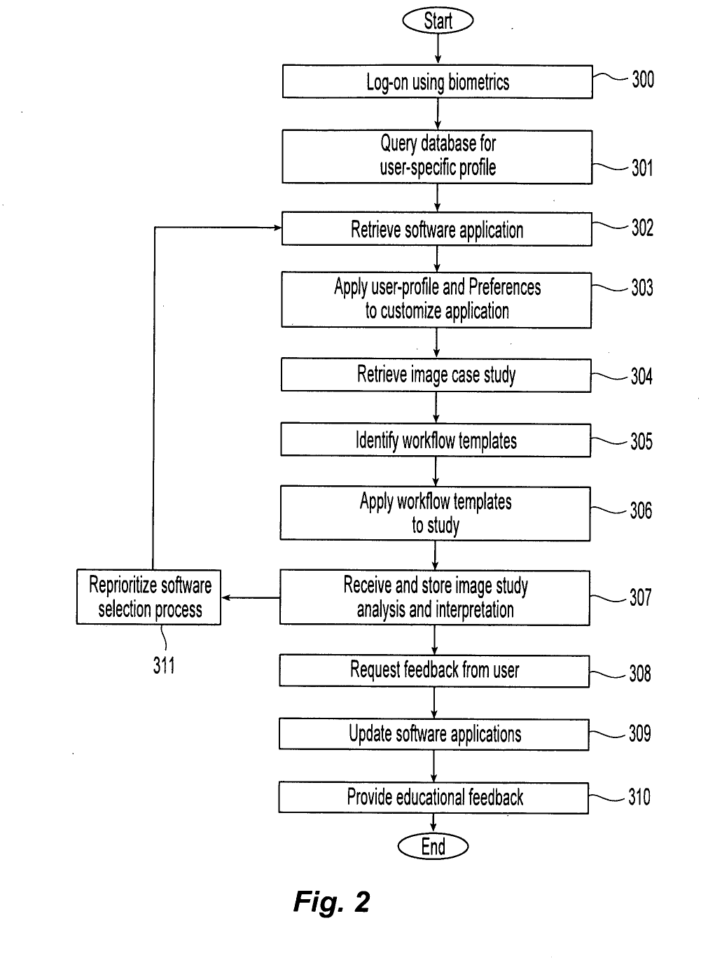

### DESCRIPTION OF THE INVENTION

The present invention relates to an image archival and workflow system 100, which is included in a single, fully integrated PACS workstation, and that provides transparent and instantaneous access to a variety of software programs, each of which is fully integrated into a single workflow engine. The present invention includes a “portal” which serves as a “meta-worklist” which can span across multiple PACS systems and multiple information systems, including (but not limited to) the radiology information system (RIS), hospital information system (HIS) and patient electronic medical record (EMR).

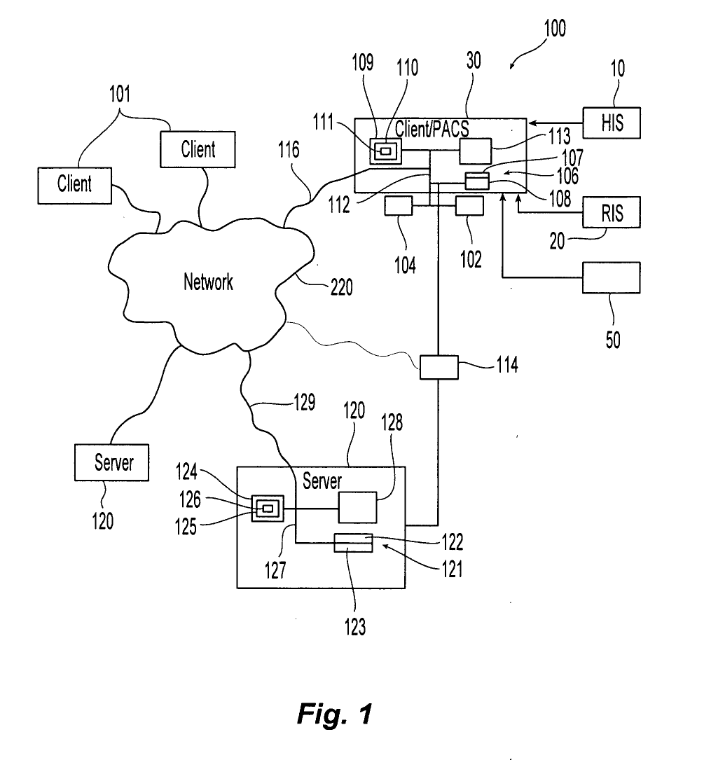

According to one embodiment of the image archival and workflow system 100 illustrated in FIG. 1, is included in the PACS 30, and designed to interface with existing information systems such as a Hospital Information System (HIS) 10, a Radiology Information System (RIS) 20, and an imaging system 50, among other systems. According to one embodiment of the invention, the image archival and workflow system 100 may be configured to conform with the relevant standards, such as the Digital Imaging and Communications in Medicine (DICOM) standard, DICOM Structured Reporting (SR) standard, the Radiological Society of North America's Integrating the Healthcare Enterprise (IHE) initiative, and/or other standards.

According to one embodiment of the invention, bi-directional communications between the image archival and workflow system 100 and the information systems, such as the HIS 10 and RIS 20, etc., allows the image archival and workflow system 100 to retrieve information from these systems, update information therein and provide the desired software applications for use with viewing the desired images.

According to one embodiment of the invention, the image archival and workflow system 100 is included in a PACS 30, such as a personal computer (PC) or client. According to one embodiment, the system 100 includes an imaging display device 102 that is capable of providing high resolution of digital images in 2-D or 3-D, for example. According to another embodiment of the invention, the system 100 may include a mobile terminal, such as a mobile computing device, or a mobile data organizer (PDA), that is operated by the user accessing the program remotely from the system 100.

According to one embodiment, methods and systems consistent with the invention may be carried out by providing an input mechanism 104 (see FIG. 1), or user selection device, including hot clickable icons etc., or selection buttons, in a menu, dialog box, or a roll-down window of an interface that is provided at the PACS 30. According to one embodiment, commands may be input through a programmable stylus, keyboard, mouse, speech processing system, laser pointer, touch screen, or other input mechanism 104.

According to one embodiment of the invention, the input or selection mechanism 104 may be constituted by a dedicated piece of hardware. Alternatively, the functions of the input or selection mechanism 104 may be executed by code instructions that may be executed on the client processor 106. According to one embodiment, the display unit 102 may display the selection window and a stylus or keyboard for entering a selection, for example.

As described in copending U.S. patent application Ser. No. 11/512,199, filed Aug. 30, 2006, which is hereby incorporated by reference in its entirety, a multi-functional programmable stylus 104 may be provided to enable input of gestures, symbols, and/or icons through the imaging display device 102. According to one embodiment, other actions may be performed by the multi-functional programmable stylus 104 that are intrinsic to the image display device 102, such as navigation, interpretation, and electronic consultation processes. The actions performed by the multi-functional programmable stylus 104 on the image display device 102 may be superior to actions that are performed using traditional computer keyboard or mouse methods, both within the PACS 30 and Electronic Medical Report (EMR).

The PACS 30 typically includes a processor 106 that operates as a client data processing device. The processor 106 may include a central processing unit (CPU) 107 or parallel processor and an input/output (I/O) interface 108, a memory 109 with a program 110 having a data structure 111, wherein all of the components are connected by a bus 112. Further, the PACS 30 may include one or more secondary storage devices 113. The bus 112 may be internal to the PACS 30 and may include an adapter for receiving a keyboard or input device 104 or may include external connections.

According to one embodiment of the invention, the imaging display device 102 may include a high resolution touch screen computer monitor. According to one embodiment of the invention, the imaging display device 102 may be configured to allow images, such as x-rays, to be readable and for gestures or symbols to be applied thereon easily and accurately. Alternatively, the imaging display device 102 can be other touch sensitive devices including tablet, pocket PC, and plasma screens. The touch screen would be pressure sensitive and responsive to the input of the stylus 104, which may be used to draw the gestures or symbols of the present invention, directly onto the image displaying device 102.

According to one embodiment of the invention, high resolution goggles may be used to provide end users with the ability to review images without the physical constraints of an external computer. For example, a surgeon may wear specialized high resolution goggles to display the cross-sectional radiological image of a brain tumor in 3-D format and may note symbols or gestures on the image, to highlight the pathology in question and to report pertinent characteristics (i.e., anatomic localization, size, etc.), to serve as a guide during surgery. These goggles may be used for image-guided surgery and may serve to provide consultation on pertinent findings during the course of surgery.

According to another embodiment of the invention, an internal medicine physician may use these specialized goggles to review images with embedded gestures or symbols. The images could be downloaded using wireless technology and displayed on the goggles, thereby eliminating the need for a computer screen for image display.

According to one embodiment, the graphical user interface associated with the PACS 30 may be a client application that is written to run on existing computer operating systems, such as existing PACS 30. According to one embodiment, the client application may be ported to other personal computer (PC) software, personal digital assistants (PDAs), and cell phones, and any other digital device that has a screen or visual component and appropriate storage capability.

The processor 106 at the PACS 30 may be located internal or external thereto, and may execute a program 110 that is configured to include predetermined operations. The processor 106 may access the memory 109 in which may be stored at least one sequence of code instructions comprising the program 110 and the data structure 111 for performing predetermined operations. The memory 109 and program 110 may be located within the PACS 30 or may be located external thereto.

Note that at times the system of the present invention is described as performing certain functions. However, one of ordinary skill in the art will readily appreciate that the program 110 may be performing the function rather than the entity of the system itself.

According to one embodiment of the invention, the program 110 that runs the image archival and workflow system 100 may include a separate program code for performing a desired operation or may be a plurality of modules that perform sub-operations of an operation, or may be part of a single module of a larger program 110 providing the operation. The modular construction facilitates adding, deleting, updating and/or amending modules therein and/or features within the modules.

According to one embodiment, the processor 106 may be adapted to access and/or execute a plurality of programs 110 that correspond to a plurality of operations. An operation rendered by the program 110 may include, for example, supporting the user interface, performing data mining functions, performing e-mail applications, etc.

According to one embodiment, the data structure 111 may include a plurality of entries, each entry including at least a first storage area that stores the databases or libraries of image files, for example.

According to one embodiment, the storage device 113 may store at least one data file, such as image files, text files, data files, audio, video files, etc., in providing a particular operation. According to one embodiment, the data storage device may include, for example, a database, such as a distributed database that is connected via a network, for example. According to one embodiment, the database may be a computer searchable database. According to one embodiment, the database may be a relational database. According to one embodiment, the storage device 113 may be connected to the server 120 and/or the PACS 30, either directly or through a communication network, such as a LAN or WAN. According to one embodiment, an internal storage device 113, or an external storage device 114 is optional, and data may also be received via a network and directly processed.

While the database 113 or 114, for example—though separately provided—is a component of the program 110, it functions in parallel to the various software applications being run on the workstation 30. The interactions between the database 113, the end-user, and the program 110, are multi-directional and often taking place in parallel to one another.

According to methods and systems consistent with the present invention, the PACS 30 may be connected to other client computers 101 and/or servers 120, and other medical equipment such as X-ray machines 50 or other imaging equipment. The PACS 30 may also include, or be connected to administration, billing or other systems. According to one embodiment, the connections may be provided via a communication link 116 as a client communication means, using a communication end port specified by an address or a port. According to one embodiment, the communication link 116 may include a mobile communication link, a switched circuit communication link, or may involve a network of data processing devices such as a LAN, WAN, the Internet, or combinations thereof. In particular, the communication link may be to e-mail systems, fax, telephone, wireless communications systems such as pagers and cell phones, wireless PDA's and other communication systems.

According to one embodiment, the communication link 116 may be an adapter unit capable of executing various communication protocols in order to establish and maintain communication with the server 120, for example. According to one embodiment, the communication link 116 may be constituted by a specialized piece of hardware or may be realized by a general CPU that executes corresponding program instructions. According to one embodiment, the communication link 116 may be at least partially included in the processor 106 to execute corresponding program instructions.

According to one embodiment consistent with the present invention, if a server 120 is used in a non-distributed environment, the server 120 may include a processor 121 having a CPU 122 or parallel processor, which is a server data processing means, and an I/O interface 123. According to one embodiment, the server 120 may be constituted by a distributed CPU 122, including a plurality of individual processors 121 that are located on one or a plurality of machines. According to one embodiment, the processor 121 of the server 120 may be a general data processing unit. According to another embodiment, the processor 121 may include a data processing unit having large resources (i.e., high processing capabilities and a large memory for storing large amounts of data).

According to one embodiment, the server 120 may include a memory 124 with program 125 having a data structure 126, wherein all of the components may be connected by a bus 127. According to one embodiment, the bus 127 or similar connection line may include external connections, if the server 120 is constituted by a distributed system. According to one embodiment, the server processor 121 may have access to a storage device 128 for storing preferably large numbers of programs for providing various operations to the users.

According to one embodiment, the data structure 126 may include a plurality of entries, each entry including at least a first storage area which stores image files, for example. According to an alternative embodiment, the data structure 126 may include other stored information as one of ordinary skill in the art would appreciate.

According to one embodiment, the server 120 may be a single unit. According to an alternative embodiment, the server 120 may be a distributed system of a plurality of servers 120 or data processing units, and may be shared by multiple users in direct or indirect connection to each other. According to one embodiment, the server 120 may execute at least one server program for a desired operation, which may be needed in serving a request from the PACS 30. According to one embodiment, the communication link 129 from the server 120 may be adapted to communicate with a plurality of clients.

According to one embodiment, the invention may be implemented in software that may be provided in a client and server environments. According to one embodiment, the invention may be implemented in software that can be provided in a distributed system over a computerized network across a number of client systems. Thus, in the present invention, a particular operation may be performed either at the client or the server, at the edge of a network or at the center, or both. Therefore, at either the client or the server, or both, corresponding programs for a desired operation/service are available.

According to one embodiment, in a client-server environment, at least one PACS 30 and at least one server 120 are each connected to a network 220 such as a Local Area Network (LAN), Wide Area Network (WAN), and/or the Internet, over communication links 116, 129. Further, even though the systems HIS 10, RIS 20, and imaging equipment 50, are shown as directly connected to one another, it is known that these systems may be connected to the client 101 or PACS 30 over a LAN, WAN, and/or the Internet via communication links. According to one embodiment, interaction with users may be through secure and non-secure internet connectivity. Thus, the steps in the methods consistent with the present invention are carried out at the client computer 101 or at the server 120, or at both. According to one embodiment, the server 120 may be accessible by the client computer 101 over for example, the Internet using a browser application or the like.

According to one embodiment, the client computer 101 may communicate via a wireless service connection. According to one embodiment, the server system 120 may communicate with network/security features, via a wireless server, which connects to, for example, voice recognition. However, one of ordinary skill in the art will appreciate that other systems may be included.

In another embodiment consistent with the present invention, the PACS

may be a basic system and the server 120 may include all of the components necessary to support the software platform of the invention. Further, the present client-server system may be arranged such that the PACS 30 may operate independently of the server system 120, but that the server system can be optionally connected. In the former situation, additional modules may be connected to the PACS 30. In another embodiment consistent with the present invention, the PACS 30 and server system 120 may be disposed in one system, rather being separated into two systems.

Although the above physical architecture has been described above as client-side or server-side components, one of ordinary skill in the art will readily appreciate that the above components of the physical architecture may be in either client or server, or in a distributed environment.

Further, although the above-described features and processing operations may be realized by dedicated hardware, or may be realized as programs including code instructions executed on data processing units, it is further possible that parts of the above sequence of operations may be carried out in hardware, whereas other of the above processing operations may be carried out using software.

The underlying technology allows for replication to various other sites. Each new site may maintain “state” with its neighbors so that in the event of a catastrophic failure, other server systems can continue to keep the application running, and allow the system to load-balance the application geographically as required.

Further, although aspects of one implementation of the invention are described as being stored in memory, one of ordinary skill in the art will appreciate that all or part of the methods and systems consistent with the present invention may be stored on, or read from, other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems consistent with the invention, may contain additional or different components.

Thus, the present image archival and workflow system 100 includes a single, fully integrated picture archival and communication system (PACS) workstation 30, that provides transparent and instantaneous access to a variety of software programs, each of which is fully integrated into a single workflow engine.

The system 100 of the present invention is programmed to “listen for” or retrieve HL7 (or other standards-based) messages and create a list of imaging studies (or other healthcare studies or procedures in the case of a non-imaging portal) for the user. The user (i.e., a radiologist in the event of a medical application, for example) can then create a filter that can display or manipulate a subset of the list of all studies or procedures performed and create an interpretation worklist from this filter.

In a medical application, for example, a clinician can create a list of his/her patients, tumor board cases, or another type of subset of the total number of procedures as well. The portal then can automatically bring up the appropriate viewer for the defined study. For example, a CT of the abdomen and comparison study might be viewed on a generic 3D cross sectional server side display program while an ultrasound study of the heart might be viewed using a cardiology echocardiography display and quantitative analysis program.

The “portal” of the present invention takes a given study on the “worklist” and then uses group- or user-defined protocols to determine the appropriate software to view the study. The images are then retrieved by the program from a central storage device or a distributed one and sent to the appropriate server or servers for interactive rendering and analysis and image optimization. When multiple programs are available for a given single study or combination of studies, then the system can either use preselected server-side rendering programs, or alternatively can allow the user the option of selecting the ones most appropriate for use. The system has the capability of obtaining feedback from the users as to whether the software was appropriate for the given study or studies for future reference (satisfaction score).

One advantage of this approach includes the fact that images do not need to be sent to the interpreting radiologists or clinicians, for example, which can take a great deal of time, but rather, the connection speed from the servers to the archive needs to be very high, which is easier to accomplish than achieving a similarly fast connection speed to each user. The system allows individual display and image processing and enhancement vendors to create their own hardware and software solutions using technologies such as clustering or grid computing to optimize performance. However, the vendors would need to adopt the standard of the “portal” for accessing the software package. The “portal” would define “standards or conventions” that could be used to make the user interface to various software packages more uniform and thus easier to use.

Another advantage of the approach would be that users could pick “best of breed” solutions to individual imaging display and analysis and optimization and decision support tasks and then pay for the use of the appropriate software using a pay-per-use model (although multiple different business models could be employed). The “portal” of the present invention, keeps track of which software is being utilized. Users could have a large number of options for image display and analysis and could change when desired. This would allow subspecialized applications to be developed for niche applications such as cardiac CT or MR, spectroscopy, obstetrical ultrasound, and so on, by vendors who have the expertise in those areas and who are not able to compete as complete PACS providers.

Performance over this system would be expected to be as fast and in some cases much faster than solutions that require processing and display to occur at the local workstation. Auditing access to patients and various software functions would be centralized and performed by the portal software.

In one method according to the present invention, a user would sign into the image archival and workflow system 100 of the PACS 30, using biometrics according to copending U.S. patent application Ser. No. 11/790,843, filed Apr. 27, 2007, which is herein incorporated by reference in its entirety.

Once the program 110 of the system 100 has identified the user, his/her unique profile is accessed in the database 113, for example, by the program 110, so that the workflow engine pulls up the customized specific end-user's individual preferences (see copending U.S. patent application Ser. No. 11/806,924, filed Jun. 5, 2007, which is herein incorporated by reference in its entirety).

In the case of a radiologist, for example, in a medical application—who is tasked with interpreting “unread” imaging exams—a single unified worklist is presented on the display 102 to that reader/user, from multiple PACS systems 30, by the program 110, based on the radiologist's credentials and skills. In other words, the program 110 would provide the customized worklist to the user based upon the user's credentials and skills as determined by the biometrics data retrieved by the program 110 upon logging onto the system 100.

In the case of a clinician, for example, a single archive is available to access images from patients under his/her care. The system 100 of the present invention creates the mechanism with which multiple image repositories can be accessed from the database 113 using a single, centrally located software application software residing on the server 120 (i.e., server-side rendering).

The present invention's user-specific profile retrieved by the program 110, determines the specific manner in which the workflow is performed by the user. Components of the user-specific profile, including the user interface (UI), reporting program, image presentation/display, visualization tools, input device, and data access (from the EMR, RIS, HIS) are all integrated into the image archival and workflow system 100.

During the course of interpretation by the radiologist, the radiologist is tasked with utilizing a number of different advanced software applications for image processing and decision support, which may vary according to a number of factors including (but not limited to) the imaging modality, anatomic region being evaluated, physical characteristics of the patient, and clinical indication. Each application has its own intrinsic advantages/disadvantages, which are viewed differently by each individual user. The system 100 of the present invention creates a single comprehensive mechanism for each individual user to select the specific application of choice for each individual study. Selection of the specific software application to be used can be performed manually (by selecting from a number of listed options), or in an automated fashion by the program 110 (through a combination of the user-specific profile and automated analysis of the workflow database 13 by the program 110).

The workflow database 113, for example, may track each individual user's workflow through use of an electronic auditing tool, as described for example, in copending U.S. patent application Ser. No. 11/586,580, filed Oct. 26, 2006, the contents of which are herein incorporated by reference in their entirety—thereby creating an electronic fingerprint of each user's workflow, which varies according to a number of individual exam characteristics (e.g., exam complexity, clinical indication, anatomic region, modality).

This user-specific workflow data is automatically entered into the workflow database 113 to record and track the myriad of human-computer interactions that take place. Included in this analysis, for example, would be the number of individual workflow steps, workstation tool usage, and different software applications selected. This user-specific workflow data can in turn be used by the program 110 to present the user with the optimum software option that best fits matches his/her workflow pattern.

The workflow database analysis by the program 110 need not be restricted to the workflow data of the individual user alone, but can also take into account comprehensive workflow data from a number of users. By the program 110 correlating workflow data from a larger pool of users (which can be selected based on similar user profiles), the program 110 can predict which application best matches the individual user based upon his/her profile, workflow pattern, and clinical indication.

Once the program 110 has performed the real-time analysis of the workflow database 113, the program 110 will present the user with a hierarchical list of options for the task at hand. This presentation of available options can be done a number of ways, based on predetermined filters established by the end-user.

One option would be to have the program 110 automatically select the “best match” (based on the program's 110 individual and/or comprehensive workflow analysis of the user).

Another option would be to have the program 110 create a rank order, based on the degree of statistical workflow compatibility. The user would then select the software application of choice from this ranked order list.

A third option may be to have the program 110 provide a standard default list base upon the user's previous selections, which is supplemented by program-derived alternative choices, which are determined by the program 110's workflow analysis. This option may be particularly important as new software applications are added to the software repository, existing software programs are upgraded, and the individual user's workflow profile changes over time.

Once the specific software application is selected by one of these pathways, the application is opened by the program 110 and applied to the imaging dataset being evaluated. During the course of the interpretation process, multiple software applications are frequently utilized simultaneously. The selection of each individual application is determined through a prompt by the end-user which notifies the program 110 that a new application is required (e.g., 3-D image processing), which can take a number of forms including (but not limited to) voice commands, manual inputs (from a multi-programmable input device such as an electronic stylus 104, mouse, or keyboard), or touch screen commands directly on the display monitor 102.

As an example, the user, for example radiologist, in interpreting a CT angiogram (CTA) of the chest (in the evaluation of pulmonary embolus) may want to apply 2-D multi-planar reconstructions of the imaging dataset, followed by computer aided detection (CAD), and then followed by image segmentation. By prompting the program 110 (in any of the aforementioned methods), the radiologist can open and close any specific application (provided from the program 110) in a few seconds. At the same time, the radiologist may elect to open two or more competitive applications to have the program 110 analyze the dataset using multiple versions of a single application.

For example, in the case of the CAD program, the radiologist may instruct the program 110 to open up 3 different CAD programs (either in parallel or in series) to analyze the same dataset. The selection of multiple competitive programs can be done in the same manner as selection of a single “best” program. In the option where the program 110 creates a hierarchical rank order list of available options, the user may select the “multiple” option and run the top 2, 3, or 4 options. After doing so, the user can invoke a manual preference list that the program 110 can store for future use.

Invoking the manual preference list is another feature of the program 110, where users can provide subjective feedback to the program 110 as to their own personal satisfaction or preferences with multiple software applications. In the previously described example of multiple CAD programs analyzing the chest CTA dataset, after utilizing 3 separate CAD programs, the radiologist may instruct the program 110 in the re-ordering of the CAD programs. This subjective user feedback becomes another integral part of the automatic selection process, along with the workflow data analysis performed by the program 110.

In the case where a user requests the program 110 to utilize his/her user-specific profile as the primary determinant of the software selection process, subjective feedback and preferences of other “similar profile” users will be factored into the selection process by the program 110.

At the conclusion of each case, the program 110 will prompt the end-user with a list of the software applications used and request feedback based on user satisfaction. This feedback mechanism can take a number of forms, including (but not limited to) a pop-up box, verbal cue, or a numerical scoring system (which can use a graphical system like gesture-based reporting). This provides another subjective measure of product performance, which is entered into the program database 113 for future analysis.

A number of potential software applications contained within the program 110 include, but are not limited to, computer-aided detection (CAD), electronic imaging databases, computerized differential diagnosis, multi-planar reconstructions, image segmentation, textual analysis, cerbral perfusion, virtual colonoscopy, quantitative analysis, advanced image processing algorithms, computerized physician order entry (CPOE), reporting, communication of critical results, clinical data archival, and imaging data archival, for example.

As one of ordinary skill in the art would recognize, this list is by no means a comprehensive list, but can provide a point of reference for the myriad of applications made available, encompassing the entire chain of events that a radiologist performs including image display, interpretation, reporting, and communication. In addition, as one of ordinary skill in the art would recognize, in non-medical applications, the list of software applications could include engineering, financial, and other applications necessary to the user's analysis.

Thus, the present invention provides the end-user with the ability to select context-specific “best of breed” software applications, which can be manually selected by the end-user or automatically selected by the program 110 (once given a specific set of selection criteria by the end-user). The selection process of these individual software applications can be updated and revised by the program 110 in a frequency and manner selected by the end-user.

One example of how a representative software application process takes place is described below. For this representative example, the selection of a decision support tool, computer aided detection (CAD) software is described. Any other software application would be selected in a similar manner.

For this particular example, the end-user is a radiologist tasked with the interpretation of a chest CT angiogram (CTA), to evaluate for the possibility of a pulmonary embolism (blood clot in the pulmonary artery).

In step 300, the user signs into the PACS system 100 using biometrics, as described above.

In step 301, the program 110 queries the database 113 to retrieve the user-specific profile as determined by the program 110, and also which can include other user-specific preferences as described in U.S. patent application Ser. No. 11/806,924. Thus, the program 110 searches its application database 113 and determines, for example, that there are six (6) CAD options available for use in this case.

In step 302, the radiologist selects the CAD option of choice. The selection process can take a number of different forms and be determined using a myriad of input variables, as will be described in the following step.

In its simplest form, the CAD program of choice can be manually selected by the radiologist based on individual preference. This manual selection process can be done at the time of image interpretation (i.e., at the point of contact) or based on a prescribed list of user-specific preferences upon choice of the CAD option.

In this particular case, the radiologist may have selected CAD algorithm D as the primary choice for all chest CTA evaluating pulmonary emboli, in step 302, for example.

An alternative to this manual pre-selection process, may take into account additional variables, which may be specific to the imaging dataset or patient being evaluated. In the case of the former (imaging dataset parameters), the radiologist may have provided instructions to the program 110 in step 302 for archival from the database 113, the selection of CAD B algorithm for CTA exams with a pre-defined program-generated degree of pulmonary artery contrast enhancement and CAD D algorithm for another degree of pulmonary artery enhancement. The program 110 would then use a standardized software application to determine a quantitative measure of pulmonary artery enhancement, and then select the CAD algorithm of choice based on the radiologist's predefined selection criteria.

In the case of the latter (patient specific parameters), the radiologist may instruct the program 110 to select a different CAD program depending upon patient body habitus (as measured by the patient body mass index [BMI]), for example. In both scenarios, the end-user instructs the program 110 to select a pre-defined software application from the database 113 in step 302, based on specific inputs. Note that the end-user is not precluded to use only a single software application program and may elect to use multiple programs for a single application.

The alternative to the manual (user) software selection process, would be a program-derived selection. In this scenario, the program 110 will query its database 113 (in real-time) and make the appropriate software application selection based on a predefined selection process in step 302. The various data points which can be used for this program-generated selection are quite numerous and can be defined by each individual user, based on his/her individual priorities. Some of the data points which can be used for the program-generated software application selection include (but are not limited to): objective workflow data; subjective user feedback; objective diagnostic accuracy data; patient-specific parameters; and imaging data-specific parameters, some of which is described in U.S. patent application Ser. Nos. 11/699,348, 11/699,349, 11/699,350, 11/699,344, and 11/699,351, all filed Jan. 30, 2007, the contents of which are herein incorporated by reference in their entirety.

The variables within each group can be further stratified by the program 110 to create more detailed selection criteria. For example, the end-user may provide the program 110 with a specific priority as to how objective workflow data will be analyzed by the program 110. He/she may instruct the program 110 to only analyze workflow data from his/her own workflow database 113, for example.

Alternatively, the radiologist may instruct the program 110 to analyze workflow data from all end-users with similar profiles, or instead only subspecialty-trained radiologists for that particular exam type. By creating such a quantitative model for hierarchical ranking of software applications, each individual end-user can determine which variables to include in the program-derived analysis, the specific weighting of each variable, and what specific sub-groups of the program 110 to use for each analysis.

In another embodiment, the end-user may not wish to take such a proactive role in the program-derived software selection process, and instead may rely entirely on the program 110. This can be done by the user simply selecting the “automated default” option for software selection, which would have the program 110 provide a pre-defined statistical analysis of the various databases 113 etc., to select a rank order of the available software application options. At any time, the end-user can simply switch between “manual” and “automated” selection options through a single computer command.

Thus, the manner in which the program-derived software options are presented to the user may also be determined by individual end-user preferences. The user can instruct the program 110 to select the “single best” program, (based on the defined selection process) or present a hierarchical “rank order” list of available programs, from which the individual user may select the software application program to be utilized at that time.

Since multiple variables can go into the program-derived analysis, the program 110 may provide a different rank order depending upon the variables with highest weighting. In this example of CTA CAD, the program-derived rank order may appear as follows: Patient body habitus—a) BMI<18.5: rank order: CAD programs D, A, C; b) BMI 18.5-24.9: rank order: CAD A, C, B; c) BMI 25.0-30.0: rank order: CAD E, F, B; and d) BMI>30.0: rank order: CAD F, E, B; Degree of pulmonary artery enhancement (scale of 1-10)—a) Enhancement 1-4: rank order CAD programs C, F, A; b) Enhancement 5:7: rank order CAD programs E, B, C; and c) Enhancement 8-10: rank order CAD programs B, A, D; Prior history of pulmonary embolism—a) Pre-existing history of embolism: rank order CAD programs B, C, E; b) No prior history of embolism: rank order CAD programs B, A, F; Acquisition parameters (collimation)—a) Collimation<1.25 mm: rank order CAD programs C, F, A; b) Collimation 1.25-2.5 mm: rank order CAD programs C, B, D; and c) Collimation>2.5 mm: rank order CAD programs B, E, D.

In this particular example of the CTA CAD program, the program 110 may present the radiologist with the following rank order: CAD program D, CAD program A, CAD program F, CAD program B, CAD program E, and CAD program C (in step 301).

The radiologist may elect to use both CAD programs D and A for the desired application in step 302, with the ability to switch “back and forth” between the two different applications or display both simultaneously (by color coding the different applications in a single overlay, for example).

In step 303, the program 110 then applies the User interface (UI) and workflow engine specifications in accordance with the individual end-user preferences. Thus, once a specific study is selected in step 302, these parameters will be further modified by the program 110 in accordance with specific parameters of the specific study being evaluated.

In step 304, the user selects a case for review/interpretation from the customized worklist provided by the program 110 based on the user profile.

In step 305, the program 110 will then query the user-specific workflow database 113 to identify specific workflow templates specific to the exam (e.g., head CT) and clinical indication (e.g., stroke) as described for example, in copending U.S. patent application Ser. No. 11/586,580. The program 110 will present multiple options to the user for selection including (but not limited to): customized workflow template based upon user-specific profile and pre-existing user-specific workflow historical data; generic workflow template based upon peer group (similar user profiles) workflow historical data; and generic workflow template based upon community-wide (comprehensive) workflow historical data.

In step 306, the user may select the desired automated workflow template and the program 110 will present the data using the specific software application required for the selected exam. (Note: If the user prompts the manual workflow command in step 302, the program 110 will allow the user to input everything related to that application, in a manner currently in practice.)

In step 307, the user then conducts his review/interpretation or analysis using the appropriate software application. For example, in a typical radiologist interpretation process of a volumetric imaging dataset (e.g., CT or MRI), the various applications being utilized include the following: data access (both clinical and imaging data); image display/presentation; navigation; image processing; decision support; and reporting/communication.

Thus, each individual software application would be run through this workflow chart in the specific order of the desired end-user as presented by the program 110. If the automated workflow template is employed, the selection process would be automated by the program 110, thereby not requiring end-user input. If the manual workflow option is employed, the end-user would be required to provide active input for the order and selection of these software applications.

In step 308, after each software application program is used, the end-user will be presented by the program 110 with an optional subjective feedback pop-up box to rate the software application utilized, which in turn is stored in the “subjective feedback” portion of the database 113.

In step 309, the program 110 may provide end-users with the capabilities of viewing updated data on software application analysis on a periodic basis, so that software selection can be adjusted manually or through adjustments in the program-derived selections.

These program-generated updates can be provided by the program 110 based on specific end-user preferences. They can take a number of different forms including (but not limited to): updated statistical analysis (of workflow and/or diagnostic accuracy) with changes in program-derived rank orders; changes in subjective feedback from specific user groups; new software application options added to database 113; and updates on existing software applications and corresponding changes to database 113 analysis (i.e., prior versus updated software analyses).

In step 310, the program 110 can also provide educational/training feedback to each individual user based on their own workflow data, as it relates to different software applications and peer groups. For instance, one user may be using only 65% of the intrinsic functionality within a given software application, while another user may be using 90% of functionality. The specific portions of the software application not being used can be highlighted by the program 110 and be shown to the individual user for review. At the same time, the program 113 can show the user how their workflow habits vary from different peer groups (e.g., similar user-specific profiles, academic radiologists, subspecialty or general radiologists, etc.). By the program 110 providing this data to the individual user, he/she can identify different ways they can modify their own individual workflow and utilization/selection of software applications to enhance performance (which can be measured by productivity and/or diagnostic accuracy measures, each of which can be tracked and analyzed from the workflow and QA databases 113 by the program 110, respectively).

If the radiologist continues to operate in a manner that does not utilize the full functionality of the software application, then the program 110 may elect to reprioritize the software selection process in step 311.

For example, a radiologist selecting a specific multi-planar reconstruction (MPR) software application may not be using the 3-D reconstruction capabilities when interpreting a CT of the hip in the evaluation of trauma. The program 110 can prompt the radiologist with this information and ask him/her if they would be interested in on-line educational material, new automated workflow templates to incorporate this additional functionality, or to change to another MPR program that may not have this added functionality, but that provides the particular radiologist with the enhanced workflow (in the absence of that particular capability).

By doing so, the program 110 provides an ability to analyze user workflow habits, make recommendations for improvements, adjust software recommendations in keeping with each individual user's preferences and work habits, and create automated workflow templates to accommodate each individual user's own habits.

As described above, a number of ancillary technologies can be integrated into the program 110 to facilitate workflow and data analysis.

For example, an electronic auditing tool as described in copending U.S. patent application Ser. No. 11/586,580, is required to record the individual actions a user engages in when using the program 110. This provides the data contained in the workflow database 113, for example. In turn, this workflow data can be used to derive automated workflow templates.

User-specific profiling as described in U.S. patent application Ser. No. 11/806,924, includes one advantageous element of the program 110, because it provides a mechanism by which an individual end-user can query subjective preferences and experiential data of similar users. If, for example, the user-specific profile has identified a specific software application that appears to demonstrate improved efficacy in one particular profile group, this data can be shared with other users within that group, with the goal of creating “best practice” guidelines (and the associated technical solutions required), based on individual user characteristics.

Quality assurance scorecards described above, particularly those for radiologists, as in copending U.S. patent application Ser. No. 11/699,344, provides an objective means to track diagnostic accuracy of each individual end-user and correlate these data points with the different technologies being used. For the different software applications contained within the program 110, this diagnostic accuracy data can be used to help in the selection process of various software application options (along with subjective perceptions and objective workflow data).

Thus, the present invention describes an alternative architectural configuration that addresses many of the challenges associated with proprietary PAC Systems. The proposed system 100 is one that represents a Radiology “Portal” although the portal concept is not meant to be limited to radiology but can serve as a generalized healthcare portal. The image archival and workflow system of the present invention provides a flexible, high performance and dynamic means for visualization, enhancement, and analysis of the entire spectrum of images not possible with current systems. This approach can be used in other imaging and non imaging specialties in healthcare as well.

Thus, it should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method of providing an image archival and workflow system, comprising:
retrieving a user-specific profile from a database which includes predetermined workflow preferences;
retrieving a software application from a database based on said predetermined workflow preferences;
customizing said software application utilizing information from said workflow preferences and said user-specific profile;
retrieving an image for analysis and interpretation; and
performing said analysis and interpretation on said image using said customized software application.

2. The method according to claim 1, wherein said workflow preferences include objective workflow data; subjective user feedback; objective diagnostic accuracy data; patient-specific parameters; and imaging data-specific parameters.

3. The method according to claim 1, wherein said workflow preferences are prioritized.

4. The method according to claim 1, further comprising:
analyzing workflow data from a plurality of users with similar profiles to determine a weighting of predetermined variables in said review and interpretation step.

5. The method according to claim 1, wherein said retrieving step is an automatic default which provides a rank order of available software applications.

6. The method according to claim 1, wherein said preferences includes automatically choosing a single software application.

7. The method according to claim 5, wherein said rank order depends upon variables including at least one of patient body habitus, a degree of pulmonary artery enhancement, a prior history of pulmonary embolism, and acquisition parameters.

8. The method according to claim 1, wherein a plurality of software applications are retrieved and customized, and said plurality of customized software applications are displayed simultaneously.

9. The method according to claim 1, further comprising:
customizing said software application by applying additional predetermined parameters from a case study related to said image.

10. The method according to claim 9, further comprising:
identifying predetermined workflow templates specific to said case study.

11. The method according to claim 10, further comprising:
providing said predetermined workflow templates based upon at least one of said user-specific profile, a user-specific workflow historical data; a generic workflow template based upon peer group workflow historical data; and a generic workflow template based upon comprehensive workflow historical data.

12. The method according to claim 11, further comprising:
displaying said image using said software application and including said workflow templates.

13. The method according to claim 12, wherein said analysis and interpretation includes a utilizing at least one of data access, an image display, navigation, image processing, decision support, communication, and reports.

14. The method according to claim 1, further comprising:
receiving feedback from a user regarding use of said software application.

15. The method according to claim 1, further comprising:
providing a user with updates on said software application.

16. The method according to claim 15, wherein said updates include at least one of an updated statistical analysis with changes in rank orders, changes in subjective feedback from specific user groups, and changes and updates to software applications in said database.

17. The method according to claim 1, further comprising:
providing educational feedback to a user based on data produced during a user's use of said customized software application.

18. The method according to claim 1, further comprising:
recording a user's action for auditing purposes when using said customized software application.

19. An image archival and workflow system comprising:
at least one memory containing at least one program comprising the steps of:
retrieving a user-specific profile from a database which includes predetermined workflow preferences;
retrieving a software application from a database based on said predetermined workflow preferences;
customizing said software application utilizing information from said workflow preferences and said user-specific profile;
retrieving an image for analysis and interpretation; and
performing said analysis and interpretation on said image using said customized software application; and
a processor for running the program.

20. A computer-readable medium for an image archival and workflow system, said computer system containing a program which performs the steps of:
retrieving a user-specific profile from a database which includes predetermined workflow preferences;
retrieving a software application from a database based on said predetermined workflow preferences;
customizing said software application utilizing information from said workflow preferences and said user-specific profile;
retrieving an image for analysis and interpretation; and
performing said analysis and interpretation on said image using said customized software application.
